(19) United States
(12) Patent Application Publication
(10) Pub. No.: US 2018/0374006 A1
(43) Pub. Date: Dec. 27, 2018

(54) DETERMINING PATHS OF SHOPPERS IN A SHOPPING VENUE

(71) Applicant: International Business Machines Corporation, Armonk, NY (US)

(72) Inventors: Lisa Seacat DeLuca, San Francisco, CA (US); Jeremy A. Greenberger, Raeigh, NC (US)

(21) Appl. No.: 15/629,121

(22) Filed: Jun. 21, 2017

(51) Int. Cl. G06Q 10/04; G06Q 30/02; G06Q 10/08; G06F 17/30

(52) U.S. Cl. CPC G06Q 10/047; G06F 17/30705; G06Q 10/087; G06Q 30/0201

(57) ABSTRACT

A method, system and computer program product are disclosed for identifying related products and pathways in a venue. In one embodiment, the method comprises receiving input specifying one of the products; identifying one or more routes taken from the specified product by customers who purchased the product; identifying one or more other products on said one or more routes, having a defined relationship with the specified product and purchased by customers who purchased the specified product; and generating a display of the one or more routes. In an embodiment, the other products are determined as related based on a prediction that customers who purchase the specified product have a probability of purchasing the other products. In an embodiment, products are determined as related based on mining specified data to determine which products tend to be purchased with the specified product.

### BACKGROUND

This invention generally relates to shopping in a venue, and more specifically, to determining paths or routes people take to purchase related items in a venue.

Typical in-store shopping requires the customer to go to the physical store, search for the desired items within the store, and then purchase the items from a store clerk. This traditional in-store experience may be time-consuming and inconvenient as it requires the customer actively to pursue the desired items in the store, which may be strategically placed by merchants to require the customer to traverse a large portion of the store. This may lead to consumers being discouraged from physical stores because it requires a significant time and energy investment. This traditional in-store experience of customers may also involve store employees or salespersons, which many consumers find overly intrusive or inconvenient.

There are many relationships between products sold in a venue. For example, in a grocery store, often times, shoppers will follow a recipe, or an established procedure or route, to get items from a list that are available in a number of different zones of a store.

### SUMMARY

Embodiments of the invention provide a method, system and compute program product for identifying related products and pathways in a shopping venue. In an embodiment, the method comprises receiving, by a computer system, input specifying one of the products in the shopping venue; identifying, by the computer system, one or more routes in the shopping venue, taken from the specified product by customers who have purchased the specified product; identifying, by the computer system, one or more products, on said one or more routes, having a defined relationship with the specified product and purchased by the customers who purchased the specified product; and generating, by the computer system, a visual display of the identified one or more routes.

In an embodiment, the invention provides a system for identifying related products and pathways in a shopping venue, the system comprising a data collection system, and a data analysis system. The data collection system is for collecting defined information about the products in the shopping venue, including locations of the products in the shopping venue and specified relationships among the products, and for capturing defined information about the customers who buy the products in the shopping venue, including information about routes taken in the shopping venue by the customers when the customers buy the products.

The data analysis system includes an input device, a processing device, and a display device. The input device is for receiving input specifying one of the products in the shopping venue. The processing device is for identifying, using said captured information about the customers, one or more routes in the venue, taken from the specified product by the customers who purchased the specified product; and for identifying, using said collected information about the products in the venue, one or more other products, on said one or more routes, having a defined relationship with the specified product and purchased by the customers who purchased the specified product. The display device is for generating a visual display of the identified one or more routes.

Embodiments of the invention provide a solution for venue operators to see how people travel through a venue to purchase related items in the venue.

Embodiments of the invention give a marketer a way to visualize a product and the paths that shoppers took from that product to the related items they purchased to better understand customer behavior and shopping routes.

### BRIEF DESCRIPTION OF THE SEVERAL VIEWS OF THE DRAWINGS

FIG. 1 shows a shopping venue and identifies categories of products available at locations in the venue.

FIG. 2 illustrates a procedure that may be used in embodiments of the invention to identify routes of shoppers from a specified product in a shopping venue.

FIG. 3 shows the shopping venue of FIG. 1 with the locations of four particular products specifically identified.

FIG. 4 shows several paths that may be taken from one of the products shown in FIG. 3 to the other three products.

FIG. 5 is a schematic block diagram of a computer network environment suitable for implementing embodiments of the invention.

### DETAILED DESCRIPTION

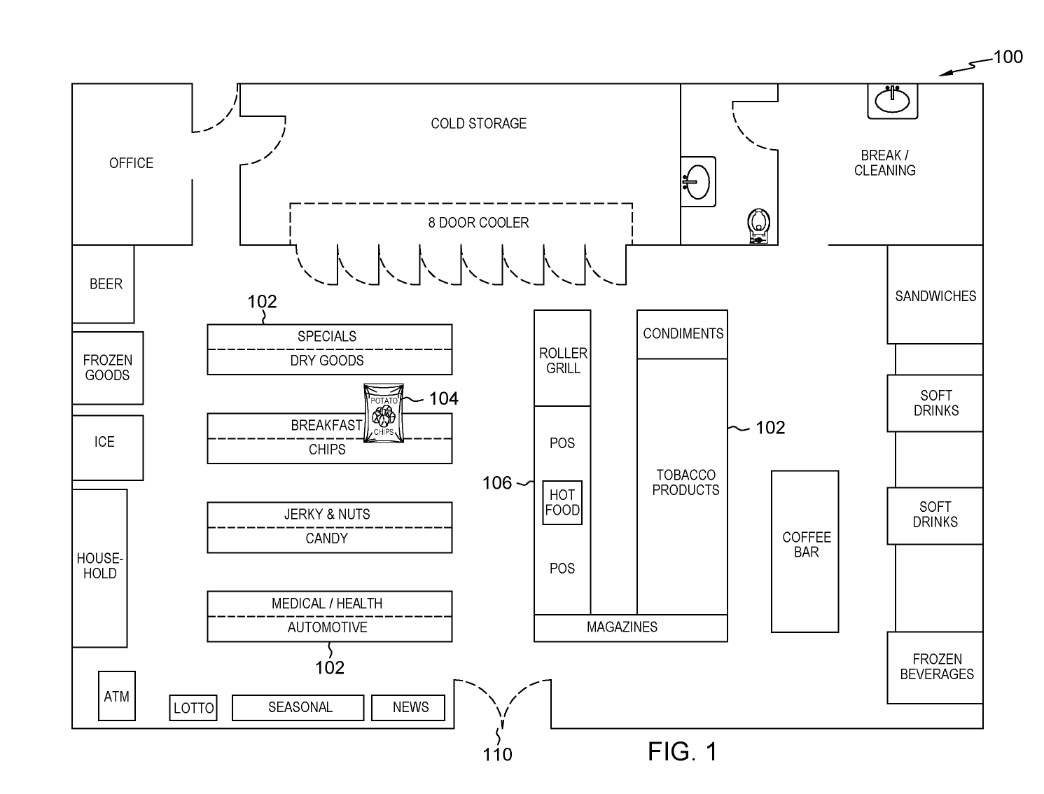

Embodiments of the invention determine routes or paths shoppers take when they purchase items in a venue. FIG. 1 illustrates a floor plan of a retail establishment 100. The floor plan may identify shelving 102 and other displays or structures on or in which items may be placed for sale. As examples, the floor plan shows the locations of dry goods, candy, household goods, and potato chips 104. The locations of the shelving and other displays or structures may be included in an electronic representation of the floor plan. The floor plan may also show one or more point-of-sale (POS) locations 106 and the locations of one or more entrances/exits 110 to/from the retail establishment. The position of the entrances/exits and the POS stations may also be in an electronic representation of the floor plan.

As mentioned above, the traditional in-store shopping experience requires the customer to go to the physical store, search for the desired items within the store, and then purchase the items from a store clerk. This may be time consuming and inconvenient, in part, because it may require the consumer to walk through a large portion of the store.

There are many relationships between products sold in a venue. For example, in a grocery store, often times, shoppers will follow a recipe, or an established plan or route, to get items from a list that are available in a number of different zones of a store. However, there currently is no easy way for a marketer to visualize a product and the paths that shoppers take from that product to the related items they purchase to better understand customer behavior and shopping routes. Embodiments of the invention provide a solution for venue operators to see how people travel through a venue to purchase related items in the venue.

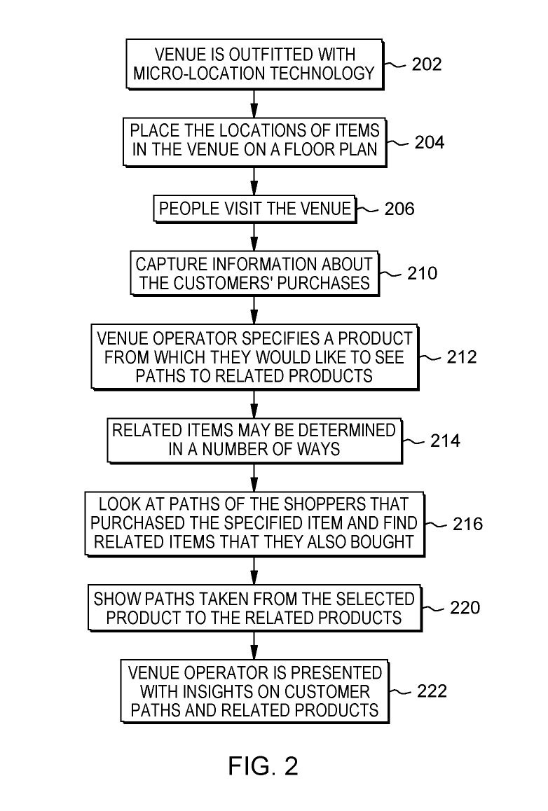

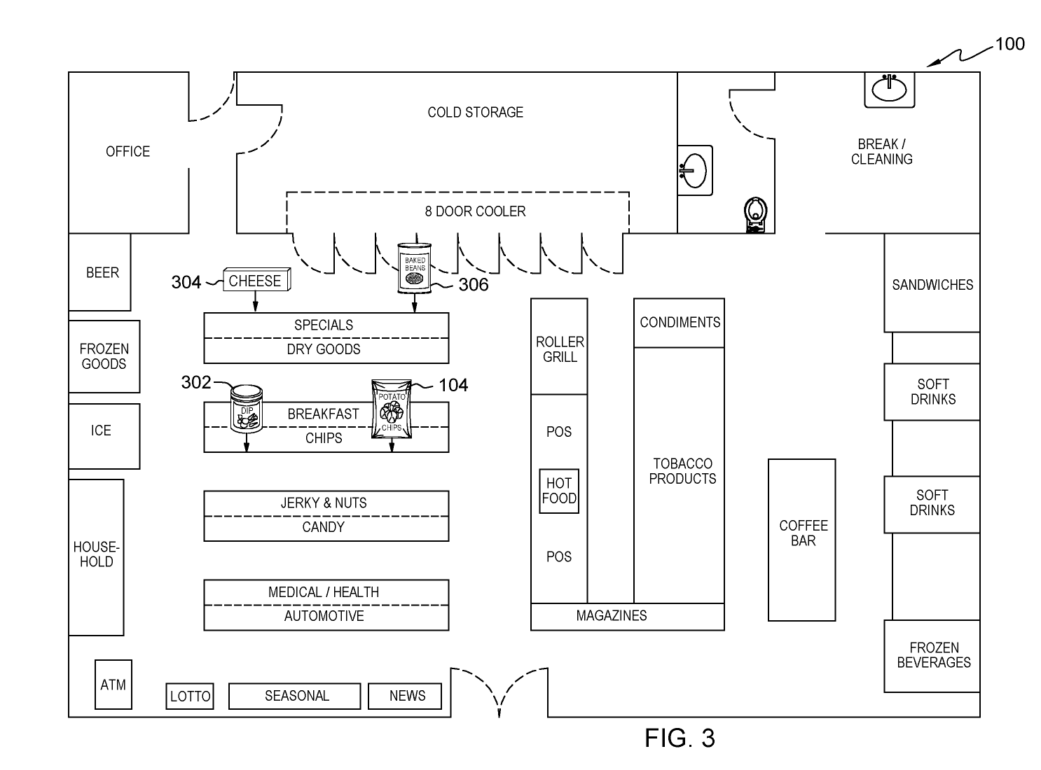

A process in accordance with an embodiment of the invention is illustrated in FIGS. 2 and 3. As represented at 202, the venue 100 is outfitted with micro-location technology and is connected to a computer or network system that includes sensors, and the computer or network system collects and then analyzes location data to identify patterns and actionable events such as the movement of customers through the venue and customers taking items from the shelves or other displays or structures.

As represented at 204, the venue operator identifies the location of items in the venue on a floor plan. Any suitable procedure may be used to do this, and suitable existing technologies are available to place the location of items in a venue on a floor plan. For instance, manual input may be used (by, for example, placing a marker on a floor plan where an item exists). This also may be done by scanning the bar code of an item in a venue to record coordinates on the floor plan.

As represented at 206, people visit the venue, and at 210, the system captures information about customers' purchases. This can be done in any suitable way, and various technologies are known for collecting the information. For example, this can be done by analyzing purchase receipts and correlating the receipts to the shoppers' paths. Information can also be obtained from various sensors in a shopping cart used by a shopper to determine which items he or she picked up. Shelf monitors that detect when an item has been taken by a shopper can also be used to capture information about the shopper's purchases.

At 212, the venue operator can specify a product from which they would like to visualize paths to related products. As represented at 214, related items may be determined in any suitable way, and for example, cognitive computing and historical patterns may be used to identify related products. Cognitive computing can be used, for example, to mine large numbers of recipes to determine which products tend to be purchased together. As examples, potato chips 104 tend to be used in recipes to create dips 302, and so do cheese 304 and baked beans 306. Therefore, there is a relationship between these four products.

Historical patterns of commonly purchased items may also be used to identify products that are related to each other. For instance, historical data may show that when someone purchases milk, there is a 60% likelihood that they also purchase cereal, and therefore a relationship can be predicted.

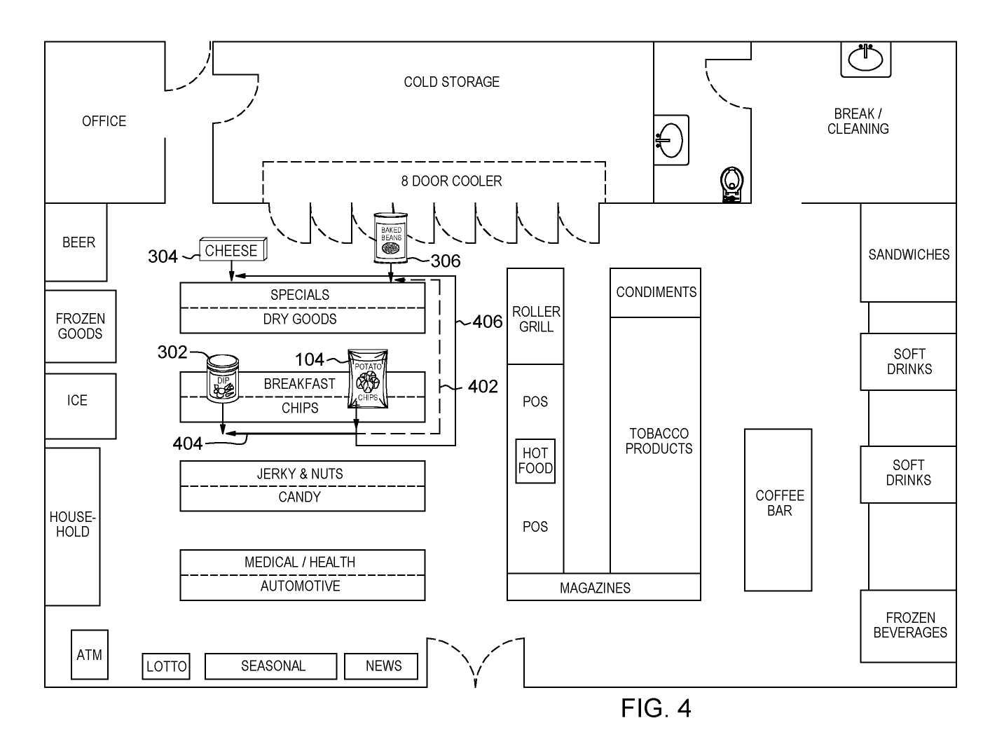

At 216, the system looks at the paths of shoppers that purchased a specified item and finds related items that those shoppers also bought. For example, with reference to FIG. 4, the system identifies paths taken by shoppers who purchased potato chips and related items on those paths. For instance, path 402 was taken by shoppers who purchased potato chips and beans, path 404 was taken by shoppers who purchased potato chips and a dip, and path 406 was taken by shoppers who purchased potato ships and cheese.

With reference again to FIG. 2, at 220, the system allows a venue operator to visualize the paths taken from the selected product to the related products. As represented at 222, the venue operator is presented with insights on customer paths and related products. For instance, the venue operator may be presented with insights on common paths that customers take to get between the related products, on the total purchases made of the related items per path, and on the likelihood of a purchase when a shopper is travelling one route versus another route.

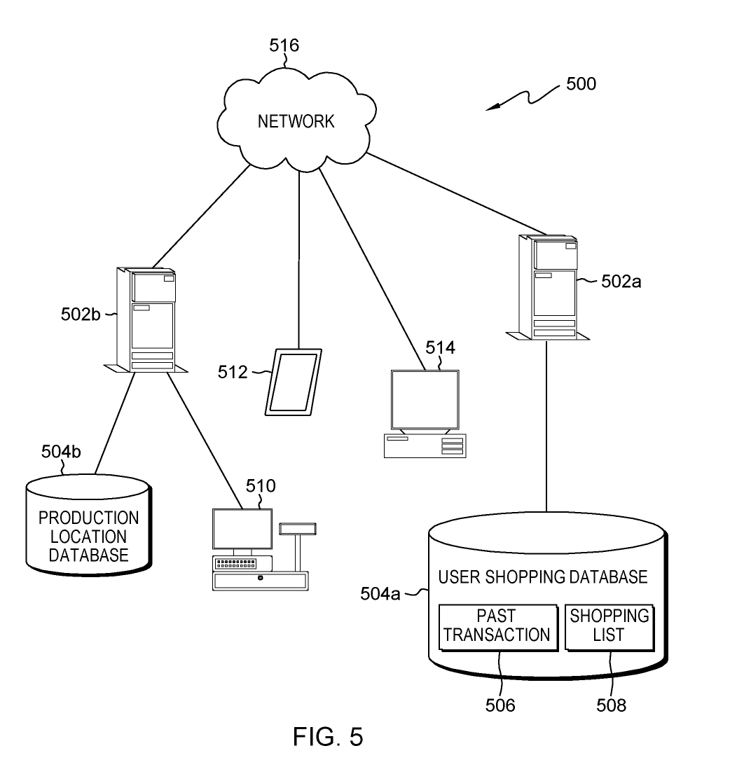

FIG. 5 illustrates a network environment 500 in which the systems and methods disclosed herein may be implemented. For example, a server system 502a may host a user shopping database 504a that stores data in user accounts for a plurality of users. A user account may store such information as records of past transactions 506 by a user and one or more shopping lists 508 of the user. A record of a past transaction 506 may include a list of items purchased in the transaction, the prices paid, the store where the transaction occurred, an identifier of a point of sale (POS) 510 at which payment was made, a time and date, and/or other information. In some embodiments, the transaction record may also list an order in which items were scanned or otherwise input to the POS 510. A shopping list 508 may be a list of items selected by the user and transmitted to the server system 502a, which then stores the list in the account of the user. For example, a user may input a shopping list by means of a mobile computing device 512 such as a mobile phone, tablet computer, wearable computer, or some other computing device. A user may also input a shopping list by means of a computer 514 such as a laptop or desktop computer. A shopping list 508 may be input by navigating an interface to a product catalog on a device 512, 514, the interface being generated by the server system 502a with reference to a product database.

A retail establishment may be associated with a server system 502b that receives records of transactions from one or more POSs 510 located at the retail establishment. The server system 502b may host or access a product location database 504b that maps products to locations in the floor plan of the store. Alternatively, the product location database 504b may be hosted or accessed by the server system 502a. A product location database 504b may map a product identifier to a location in the retail establishment. For example, a product identifier may be mapped to a shelf identifier and a shelf identifier may be mapped to a physical location in the retail establishment, e.g. in the form of globally defined coordinates or with respect to some local datum point in the retail establishment.

The server systems 502a, 502b and computing devices 512, 514 may communicate with one another by means of a network 516, such as a local area network (LAN), wide area network (WAN), the Internet, or some other network. The data connection between the server systems 502a, 502b and computing devices 512, 514 may include any wired or wireless protocol.

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

Those of ordinary skill in the art will appreciate that the architecture and hardware depicted in FIG. 5 may vary.

The description of the invention has been presented for purposes of illustration and description, and is not intended to be exhaustive or to limit the invention in the form disclosed. Many modifications and variations will be apparent to those of ordinary skill in the art without departing from the scope of the invention. The embodiments were chosen and described in order to explain the principles and applications of the invention, and to enable others of ordinary skill in the art to understand the invention. The invention may be implemented in various embodiments with various modifications as are suited to a particular contemplated use.

1. A method of identifying related products and pathways in a shopping venue, wherein a multitude of products are in the shopping venue and customers purchase the products in the shopping venue, the method comprising:
receiving, by a computer system, input specifying one of the products in the shopping venue;
identifying, by the computer system, one or more routes in the shopping venue taken from the specified product by customers who purchased the specified product;
identifying, by the computer system, one or more other products, on said one or more routes, having a defined relationship with the specified product and purchased by the customers who purchased the specified product; and
generating, by the computer system, a visual display of the identified one or more routes.

2. The method according to claim 1, wherein the identifying one or more other products having a defined relationship with the specified product includes identifying one or more other products in the shopping venue as related to the specified product based on a prediction that customers in the shopping venue who purchase the specified product have a defined probability of purchasing the one or more other products in the shopping venue.

3. The method according to claim 1, wherein the identifying one or more other products having a defined relationship with the specified product includes mining specified data to determine which of the other products in the shopping venue tend to be purchased with the specified product.

4. The method according to claim 1, wherein the identifying one or more other products having a defined relationship with the specified product includes identifying one or more other products in the shopping venue as related to the specified product based on a historical pattern of items purchased together.

5. The method according to claim 1, wherein the identifying one or more other products having a defined relationship with the specified product includes identifying on one of said routes a first product commonly bought with the specified product and a second product commonly bought with the specified product and the first product.

6. The method according to claim 1, further comprising:
collecting defined information about the products in the shopping venue, including locations of the products in the shopping venue and specified relationships among the products; and
wherein the identifying one or more other products having a defined relationship with the specified product includes using said collected information about the products in the shopping venue to identify the one or more related other products.

7. The method according to claim 1, further comprising:
capturing defined information about the customers who buy the products in the shopping venue, including information about routes taken in the shopping venue by the customers when the customers buy the products; and
wherein the identifying one or more routes in the shopping venue taken from the specified product includes using said captured information about the customers who buy the products in the shopping venue to identify the one or more routes in the shopping venue.

8. The method according to claim 7, wherein the capturing information about the customers who buy the products in the shopping venue includes:
analyzing purchase receipts of the customers; and
correlating the purchase receipts to paths of the customers in the shopping venue.

9. The method according to claim 1, further comprising providing, by the computer system, specified information about the identified one or more routes.

10. The method according to claim 9, wherein the specified information about the identified one or more routes includes:
information on common paths that the customers take to get between the related products;
information on total purchases made of the related products on each of the identified routes; and
information on a likelihood of a purchase of a particular one of the related products when the customers are travelling one of the routes versus when the customers are traveling another one of the routes.

11. A system for identifying related products and pathways in a shopping venue, wherein a multitude of products are in the shopping venue and customers purchase the products in the shopping venue, the system comprising:
a data collection system for collecting defined information about the products in the shopping venue, including locations of the products in the shopping venue and defined relationships between the products, and for capturing defined information about the customers who buy the products in the shopping venue, including information about routes taken in the shopping venue by the customers when the customers buy the products; and
a data analysis system including
an input device for receiving input specifying one of the products in the shopping venue; and
a processing device for identifying, using said captured information about the customers, one or more routes in the shopping venue, taken from the specified product by the customers who purchased the specified product; and for identifying, using said collected information about the products in the venue, one or more other products, on said one or more routes, having a defined relationship with the specified product and purchased by the customers who purchased the specified product; and
a display device for generating a visual display of the identified one or more routes.

12. The system for identifying related products and pathways in a shopping venue according to claim 11, wherein the identifying one or more other products having a defined relationship with the specified product includes identifying one or more other products in the shopping venue as related to the specified product based on a prediction that the customers in the shopping venue who purchase the specified product have a defined probability of purchasing the one or more other products in the shopping venue.

13. The system for identifying related products and pathways in a venue according to claim 11, wherein the identifying one or more other products having a defined relationship with the specified product includes mining specified data to determine which of the products in the shopping venue tend to be purchased with the specified product.

14. The system for identifying related products and pathways in a venue according to claim 11, wherein the identifying one or more other products having a defined relationship with the specified product includes identifying one or more of the other products in the shopping venue as related to the specified product based on a historical pattern of items purchased together.

15. The system for identifying related products and pathways in a venue according to claim 11, wherein the data analysis system provides specified information about the identified one or more routes, including:
information on common paths that the customers take to get between the related products;
information on total purchases made of the related products per route; and
information on a likelihood of a purchase of a particular one of the products when the customers are travelling one of the routes versus when the customers are traveling another one of the routes.

16. A computer program product for identifying related products and pathways in a venue, wherein a multitude of products are in the shopping venue and customers purchase the products in the venue, the computer program product comprising:
a computer readable storage medium having program instructions embodied therein, the program instructions executable by a computer to cause the computer to perform the method of:
receiving input specifying one of the products in the shopping venue;
identifying one or more routes in the shopping venue taken from the specified product by customers who purchased the specified product;
identifying one or more other products, on said one or more routes, having a defined relationship with the specified product and purchased by the customers who purchased the specified product; and
generating a visual display of the identified one or more routes.

17. The computer program product according to claim 11, wherein the identifying one or more other products having a defined relationship with the specified product includes identifying one or more other products in the shopping venue as related to the specified product based on a prediction that the customers in the shopping venue who purchase the specified product have a defined probability of purchasing the one or more other products in the shopping venue.

18. The computer program product according to claim 16, wherein the identifying one or more other products having a defined relationship with the specified product includes mining specified data to determine which of the products in the shopping venue tend to be purchased with the specified product.

19. The computer program product according to claim 16, wherein the identifying one or more other products having a defined relationship with the specified product includes identifying one or more of the products in the shopping venue as related to the specified product based on a historical pattern of items purchased together.

20. The computer program product according to claim 19, wherein
the method further comprises providing specified information about the identified one or more routes, including:
information on common paths that the customers take to get between the related products;
information on total purchases made of the related products per route; and
information on a likelihood of a purchase of a particular one of the products when the customers are travelling one of the routes versus when the customers are traveling another one of the routes.
